(19) United States
(12) Patent Application Publication
(10) Pub. No.: US 2016/0059767 A1
(43) Pub. Date: Mar. 3, 2016

(54) VEHICLE LAMP DEVICE AND METHOD OF MANUFACTURING THE SAME

(71) Applicant: SL Corporation, Daegu (KR)

(72) Inventors: Gi Hun Kwak, Gyeongsan (KR); Hyun Dong Roh, Gyeongsan (KR)

(73) Assignee: SL Corporation

(21) Appl. No.: 14/796,630

(22) Filed: Jul. 10, 2015

(30) Foreign Application Priority Data
Sep. 2, 2014 (KR) 10-2014-0115901

(51) Int. Cl. B60Q 1/00; F21V 23/00; F21V 5/00

(52) U.S. Cl. CPC B60Q 1/0088; F21V 5/008; F21V 23/004; F21W 2101/00

(57) ABSTRACT

A vehicle lamp device is provided and includes a housing having an accommodating portion with an open side and a connector pin disposed in the accommodating portion. A light source unit is disposed in the accommodating portion and includes one or more light sources configured to irradiate light toward the open side of the accommodating portion. Additionally, a lens is coupled to the open side of the accommodating portion and is configured to transmit light irradiated from the light sources. The connector pin is integrally formed with the housing by insert injection, and the light source unit includes a printed circuit board (PCB) having an aperture through which an end of the connector pin passes and the light sources which are installed on the PCB and irradiate light.

### CROSS-REFERENCE TO RELATED APPLICATION(S)

This application claims priority from Korean Patent Application No. 10-2014-0115901 filed on Sep. 2, 2014 in the Korean Intellectual Property Office, the disclosure of which is incorporated herein by reference in its entirety.

### BACKGROUND

1. Field of the Invention

The present invention relates to a vehicle lamp device and a method of manufacturing the same. More particularly, it relates to a vehicle lamp device that has a reduced number of parts to increase productivity and can prevent a grounding defect due to vibrations and a method of manufacturing the vehicle lamp device.

2. Description of the Related Art

Generally, a vehicle includes various types of lamps having a lighting function and an informing function (e.g., an indication function). The lighting function allows the driver of the vehicle to detect objects surrounding the vehicle while driving in low lighting conditions. The informing function is used to provide an indication to other vehicles and road users of the vehicle driving state and information regarding a license plate of the vehicle. For example, a headlamp and a fog lamp are designed for the lighting function, and a turn signal lamp, a tail lamp, a brake lamp, a side marker and a license plate lamp are designed for the signaling function. The installation standards and specifications for these vehicle lamps are defined by law, so that each function can be fully exerted.

In a vehicle lamp, a light source unit configured to irradiate light is disposed in a housing, and a connector connected to an external power source is coupled to the housing to supply power to the light source unit. In particular, since the connector should be coupled to the housing, an additional process for coupling the connector to the housing is required thus resulting in a more complex assembling process and a reduction in production efficiency. In addition, a grounding defect may occur between a connector pin included in the connector and the light source unit due to vibrations generated when a vehicle is driven.

### SUMMARY

The present invention provides a vehicle lamp device improved in productivity and in cost and size by having a reduced number of parts and a method of manufacturing the vehicle lamp device. The present invention also provides a vehicle lamp device which may prevent a grounding defect between a connector pin and a light source unit caused by vibrations of a vehicle and a method of manufacturing the vehicle lamp device. However, aspects of the present invention are not restricted to the ones set forth herein. The above and other aspects of the present invention will become more apparent to one of ordinary skill in the art to which the present invention pertains by referencing the detailed description of the present invention given below.

According to an aspect of the present invention, a vehicle lamp device may include: a housing having an accommodating portion with an open side and a connector pin disposed in the accommodating portion; a light source unit disposed in the accommodating portion and having one or more light sources configured to irradiate light toward the open side of the accommodating portion; and a lens coupled to the open side of the accommodating portion and configured to transmit light irradiated from the light sources. The connector pin may be integrally formed with the housing by insert injection, and the light source unit may include a printed circuit board (PCB) having a aperture through which an end of the connector pin passes and the light sources which are installed on the PCB and irradiate light.

According to another aspect of the present invention, there is provided a method of manufacturing a vehicle lamp device. The method includes: placing a light source unit, which includes a PCB and a light source, in a housing through an open side of the housing; passing an end of a connector pin, which is integrally insert-injected into the housing, through an aperture formed in the PCB of the light source unit and soldering the end to the PCB; and coupling a lens to the open side of the housing.

### BRIEF DESCRIPTION OF THE DRAWINGS

The above and other aspects and features of the present invention will become more apparent by describing in detail exemplary embodiments thereof with reference to the attached drawings, in which:

FIG. 1 is a view of a vehicle lamp device according to an exemplary embodiment of the present invention;

FIG. 2 is a detailed view of the vehicle lamp device of FIG. 1 according to an exemplary embodiment of the present invention;

FIG. 3 is a lateral cross-sectional view of the vehicle lamp device of FIG. 1 according to an exemplary embodiment of the present invention;

FIG. 4 is a schematic diagram illustrating the flow of light irradiated from the vehicle lamp device of FIG. 1 according to an exemplary embodiment of the present invention;

FIG. 5 is a flowchart illustrating a process of manufacturing a vehicle lamp device according to an exemplary embodiment of the present invention;

FIG. 6 is a detailed view of a vehicle lamp device according to another exemplary embodiment of the present invention; and

FIG. 7 is a lateral cross-sectional view of the vehicle lamp device of FIG. 6 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum). The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention will now be described more fully with reference to the accompanying drawings, in which exemplary embodiments of the invention are shown.

A vehicle lamp device described below may be a license plate lamp installed at the rear of a vehicle to illuminate a license plate. However, the vehicle lamp device is not limited to the license plate lamp and may also be a headlamp, a turn signal lamp, and the like. The license plate lamp is a lamp configured to illuminate a license plate to enable the number on the license plate to be recognized when a vehicle is driven at night or in a dark place (e.g., during low lighting conditions).

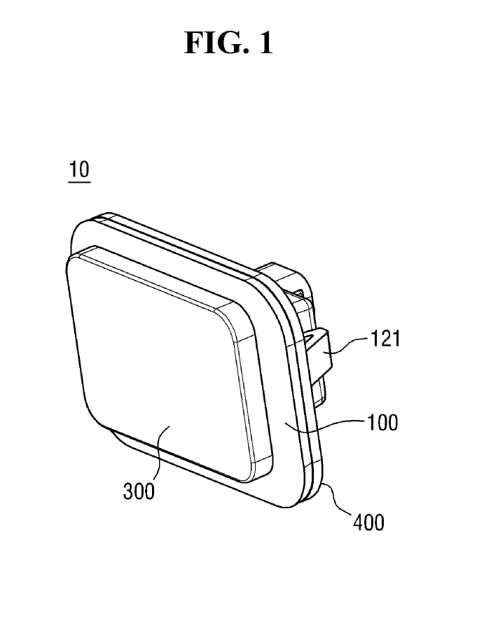

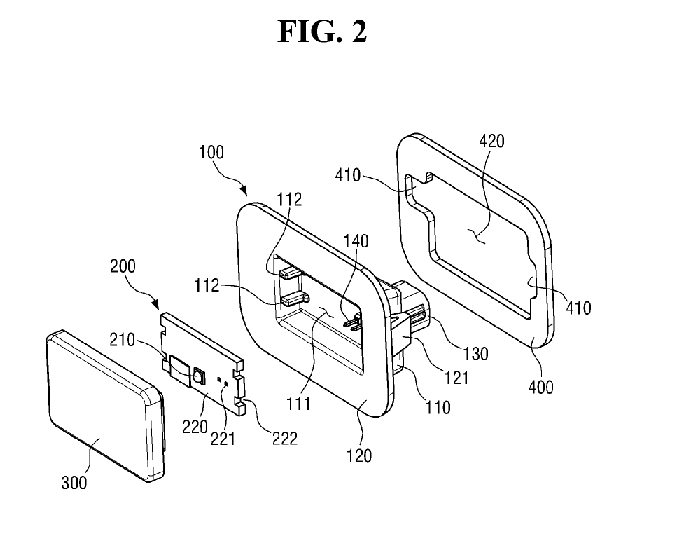

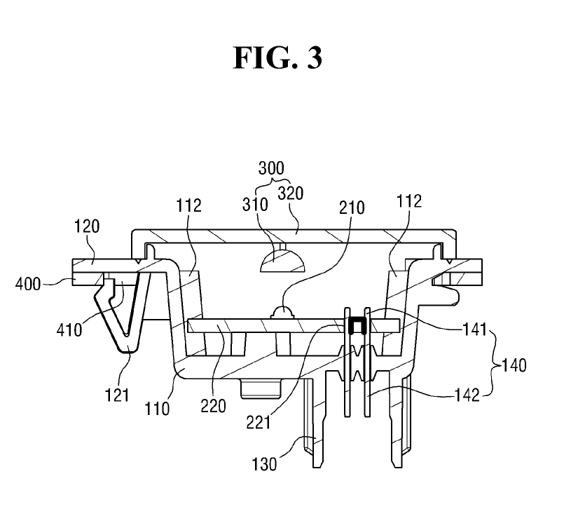

FIG. 1 is a view of a vehicle lamp device 10 according to an exemplary embodiment of the present invention. FIG. 2 is a detailed view of the vehicle lamp device 10 of FIG. 1. FIG. 3 is a lateral cross-sectional view of the vehicle lamp device 10 of FIG. 1. Referring to FIGS. 1 through 3, the vehicle lamp device 10 according to the current exemplary embodiment may include a housing 100, a light source unit 200, and a lens 300. In addition, the vehicle lamp device 10 may further include a pad 400.

The housing 100 is a component that forms the exterior of the vehicle lamp device 10 and protects the light source unit 200 disposed therein. The housing 100 may include an accommodating portion 110, a connector portion 130, and an extending portion 120. The accommodating portion 110, the connector portion 130, and the extending portion 120 may be integrally injection-molded. In addition, connector pins 140 may be integrally formed with the housing 100 by insert injection molding and may be electrically connected to an external power source to supply power to the light source unit 200. Particularly, the insert injection molding is a method of integrally molding a plastic or metal material in a mold made of a material different from the plastic or metal material. For example, the insert injection molding may be a method of integrally molding the connector pins 140 made of a metal material in the housing 100 (i.e., a mold) made of a plastic material.

The accommodating portion 110 may include an opening 111 at a first side and may also include an accommodating space therein. Accordingly, the light source unit 200 may be installed in the accommodating portion 110 through the open first side. In other words, the light source unit 200 may be installed within the housing 100. The connector portion 130 may be integrally coupled to a second side of the accommodating portion 110. In the current exemplary embodiment of the present invention, the connector portion 130 may be integrally coupled to the second side which is opposite the open first side of the accommodating portion 110. In addition, the lens 300 may be coupled to the open first side of the accommodating portion 110. Accordingly, the opening 111 of the accommodating portion 110 may be closed.

Further, one or more guide protrusions 112 may protrude toward the inside of the accommodating portion 110. Particularly, the guide protrusions 112 may extend along a direction in which the light source unit 200 is inserted into the accommodating portion 110. In addition, the guide protrusions 112 may be inserted into guide grooves 222 of a printed circuit board (PCB) 220 which will be described later. Therefore, the light source unit 200 may be slid into the accommodating portion 110 along the guide protrusions 112. The

PCB board 220 and the light source unit 200 may be operated by a controller having a processor and a memory.

The extending portion 120 may extend outward from the open first side of the accommodating portion 110 and may extend outward along the circumference of the first side of the accommodating portion 110. Additionally, the extending portion 120 may include a plurality of coupling hooks 121 hooked to coupling grooves 410 of the pad 400. The coupling hooks 121 may protrude toward the second side opposite to the open first side of the accommodating portion 110. In other words, the coupling hooks 121 may protrude toward the pad 400. When the coupling hooks 121 are hooked to the coupling grooves 410, the pad 400 may be tightly coupled to the housing 100 to prevent the introduction of moisture, exhaust gas, foreign matter, etc. into the housing 100. That is, the seal between the pad 400 and the housing 100 may be improved to secure an airtight or watertight seal.

The connector portion 130 may be integrally formed with the second side of the accommodating portion 110 and may protrude outward to dispose (e.g., align) second ends 142 of the connector pins 140 within the connector portion 130. Accordingly, the connector portion 130 may protect the second ends 142 of the connector pins 140 from external foreign matter. The connector portion 130 may be coupled to, e.g., a wire that is connected to the external power source. The connector pins 140 may be electrically connected to the external power source to supply power to the light source unit 200. Accordingly, the connector pins 140 may be made of a material having superior electrical conductivity. In particular, the connector pins 140 may be made of a metal material such as copper.

Furthermore, the connector pins 140 may be integrally formed with the housing 100 by insert injection molding. Particularly, the connector pins 140 may be insert injection-molded to dispose first ends 141 of the connector pins 140 in the accommodating portion 110 and dispose the second ends 142 of the connector pins 140 in the connector portion 130. The second ends 142 disposed in the connector portion 130 allow the connector pins 140 to be electrically connected to the external power source, and the first ends 141 disposed in the accommodating portion 110 allow the connector pins 140 to be connected to the light source unit 200 disposed in the accommodating portion 110.

The first ends 141 of the connector pins 140 may pass through apertures 221 formed in the PCB 220 which will be described later. The first ends 141 passing through the apertures 221 may be soldered to the PCB 220. Accordingly, the connector pins 140 may be fixed to the PCB 220 to prevent a grounding defect between the connector pins 140 and the PCB 220 due to vibrations of a vehicle. The light source unit 200 may be disposed within the accommodating portion 110 through the open first side of the accommodating portion 110. The light source unit 200 disposed within the accommodating portion 110 may be configured to irradiate light toward the open first side of the accommodating portion 110. In addition, the light source unit 200 may include the PCB 220 and a light source 210.

The PCB 220 may be configured to supply power to the light source 210 which converts electrical energy into light energy and to operate the light source 210. Accordingly, a circuit pattern may be formed on the PCB 220. In addition, the PCB 220 may include the plurality of apertures 221 through which the first ends 141 of the connector pins 140 may pass. As described above, the first ends 141 of the connector pins 140 may pass through the apertures 221 and the first ends 141 passing through the apertures 221 may be soldered to the PCB 220 to strengthen the coupling of the connector pins 140 to the PCB 220. When the PCB 220 is connected to the connector pins 140, the PCB 220 may be configured to receive power from a vehicle battery through the connector pins 140.

Further, the PCB 220 may include one or more guide grooves 222 into which the guide protrusions 112 of the accommodating portion 110 may be inserted. The guide grooves 222 may be formed at both ends of the PCB 220 in a lengthwise direction. As the guide grooves 222 are inserted into the guide protrusions 112, the light source unit 200 may be slid into the accommodating portion 110.

In particular, the light source 210 may be installed on the PCB 220 and may be configured to irradiate light toward the open first side of the accommodating portion 110. At least one light source 210 may be installed on the PCB 220. In the current exemplary embodiment, one light source 210 is provided and the light source 210 may be a light-emitting diode (LED) light source. An LED is a diode configured to emit excess energy as light when injected electrons and holes recombine. Due to the advantages of low voltage and low power consumption, the LED is being used as a light source for optical coupled devices. The light source 210 including the LED device has high energy efficiency (e.g., high light conversion efficiency and low power consumption), has a longer lifespan, and forms the light source unit 200 with low voltage and low power consumption. In addition, it will be obvious to those of ordinary skill in the art that the light source 210 can be any type of device (such as an organic light-emitting diode (OLED) or a laser diode) using an electroluminescent effect as well as the LED.

Moreover, the lens 300 may be disposed in a light irradiation direction of the light source 210 and may have a molding pattern to obtain a desired lighting pattern from the light source 210. The lens 300 may be used to induce light irradiated from the light source 210 toward a light plate (not illustrated). Additionally, the lens 300 may be coupled to the open first side of the accommodating portion 110 to close the open first side of the accommodating portion 110. Since the open first side of the accommodating portion 110 may be closed by the lens 300, the introduction of foreign matter, moisture, etc. into the accommodating portion 110 through the open first side may be prevented.

The lens 300 may be coupled to the first side of the accommodating portion 110 in various ways. In the current exemplary embodiment, the lens 300 may be coupled to the open first side of the accommodating portion 110 by ultrasonic welding. Ultrasonic welding is a method of melting and coupling different parts or materials together by instantaneously generating frictional heat at a bonding surface using ultrasonic vibrations.

This ultrasonic welding allows for coupling without the use of an adhesive, achieves a strong coupling state due to strong molecular binding, requires a minimal coupling time due to instantaneous welding, and causes minimal deformation of the product surface.

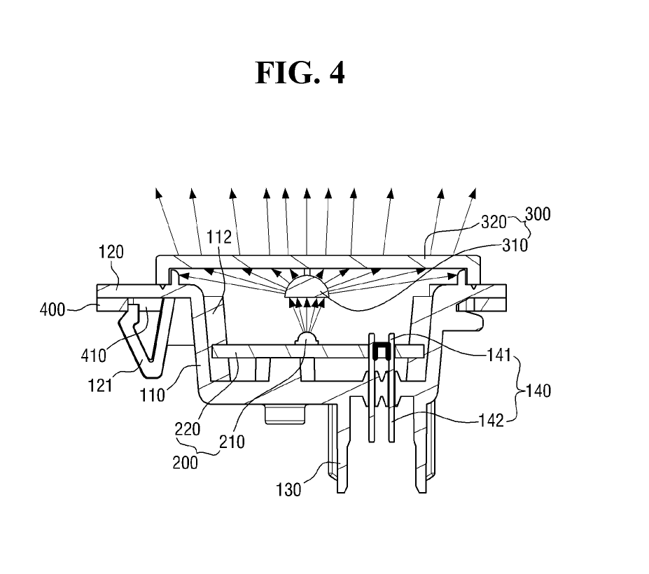

Further, the lens 300 may be configured to transmit light irradiated from the light source unit 200. Therefore, the lens 300 may be made of a transparent material. For example, the lens 300 may be made of a transparent glass material, a transparent plastic material, etc. In addition, the lens 300 may include a first lens 310 configured to diffuse light irradiated from the light source 210 and a second lens 320 configured to refract the light diffused by the first lens 310 in a predetermined pattern. This will be described in detail later with reference to FIG. 4.

The pad 400 may be coupled to the housing 100 while covering the circumference of the housing 100 (e.g., surrounding the circumference thereof). Therefore, the pad 400 may be a component that prevents the introduction of moisture, exhaust gas, foreign matter, etc. into the housing 100 or the vehicle. The pad 400 may include an insertion portion 420, into which the accommodating portion 110 is inserted, in the middle thereof and the coupling grooves 410, into which the coupling hooks 121 of the extending portion 120 are inserted and hooked, in the periphery thereof. When the coupling hooks 121 are hooked to the coupling grooves 410, the pad 400 may be coupled to the housing 100.

FIG. 4 is a schematic diagram illustrating the flow of light irradiated from the vehicle lamp device 10 of FIG. 1. Referring to FIG. 4, the flow of light irradiated from the vehicle lamp device 10 of FIG. 1 is as follows.

First, when power is supplied to the light source unit 200 through the connector pins 140, the light source 210 may be configured to irradiate light toward the open first side of the accommodating portion 110. An area over which the light source 210 irradiates light may vary based on the performance of the light source 210. However, it is generally difficult to irradiate light over a wide area using one light source.

In the current exemplary embodiment of the present invention, the vehicle lamp device 10 may be a license plate lamp, and a license plate (not illustrated) typically extends horizontally. Therefore, the area that the light source 210 should illuminate is substantially wide. Accordingly, it may be difficult to illuminate the license plate using a minimal number of light sources. Accordingly, the first lens 310 configured to diffuse light may be disposed in the light irradiation direction of the light source 210 to widen the area over which the light source 210 irradiates light. Light diffused by the first lens 310 may be refracted by the second lens 320. In addition, light incident upon the second lens 320 may be refracted in a predetermined pattern by the curvature of the second lens 320.

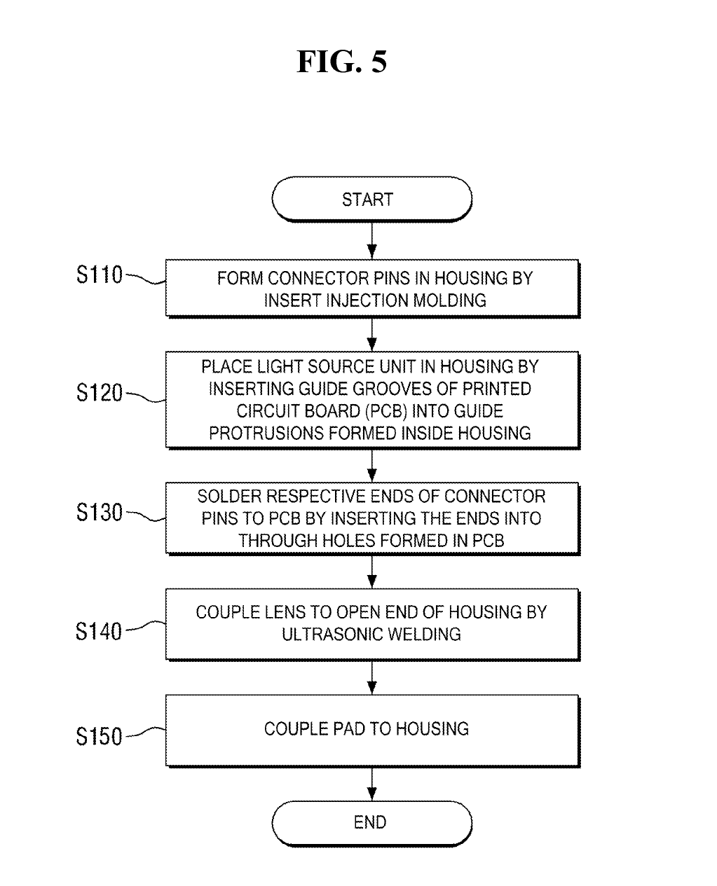

FIG. 5 is a flowchart illustrating a process of manufacturing a vehicle lamp device according to an exemplary embodiment of the present invention. Referring to FIG. 5, the process of manufacturing a vehicle lamp device according to the current exemplary embodiment is as follows. First, a housing may be manufactured using injection molding. When the housing is injection-molded, connector pins may be insert injection-molded in the housing (S110). In particular, the connector pins may be insert injection-molded to dispose (e.g., align) the first ends of the connector pins inside the housing and dispose the second ends of the connector pins in a connector portion of the housing.

A light source unit including a PCB and a light source may be disposed within the housing through an open side of the light source unit (S120). In other words, the light source unit may be disposed in an accommodating portion described above. Particularly, guide grooves formed at both ends of the PCB may be inserted into guide protrusions formed within the housing. The guide protrusions may extend in a lengthwise direction, and the PCB may be moved into the housing along the guide protrusions. In other words, the light source unit may be disposed within the housing.

In an exemplary embodiment, the guide protrusions may be formed at both ends of the PCB of the light source unit, and the guide grooves into which the guide protrusions are inserted may be formed within the housing. Therefore, the light source unit may be disposed within the housing as the guide protrusions formed at both ends of the PCB are inserted into and moved along the guide grooves formed within the housing. After the light source unit is slid into the housing, the first ends of the connector pins may be passed through apertures formed in the PCB of the light source unit. The first ends of the connector pins which may pass through the apertures may be soldered to the PCB (S130). Accordingly, the connector pins may be fixed to the PCB.

After the connector pins are soldered to the PCB, a lens may be coupled to the open side of the housing (S140). The lens may be coupled to the open side of the housing by ultrasonic welding. After the lens is coupled to the housing, a pad for preventing the introduction of foreign matter into the housing may be coupled to the housing (S150). In particular, coupling hooks which protrude toward the pad may be formed on an extending portion which extends outward from the open side of the housing, and coupling grooves to which the coupling hooks are inserted and hooked may be formed in the pad. Therefore, the pad may be more tightly coupled to the housing by hooking the coupling hooks of the extending portion to the coupling grooves of the pad.

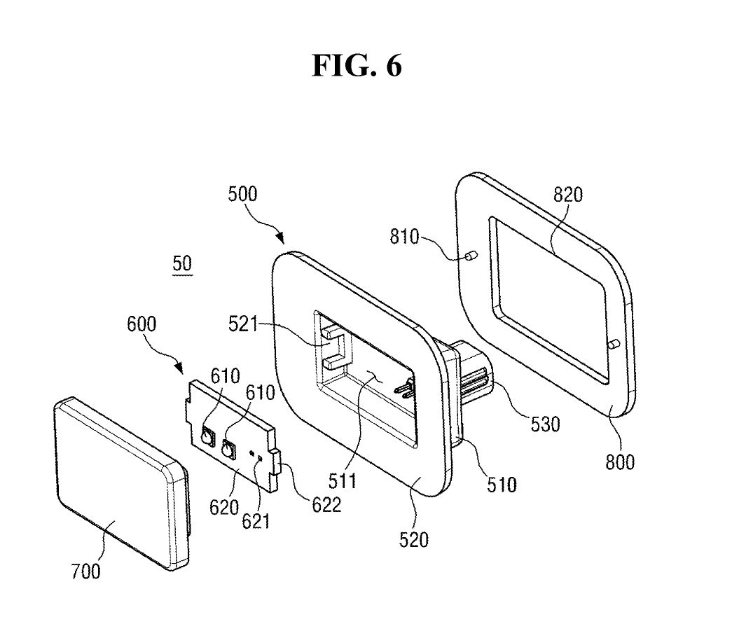

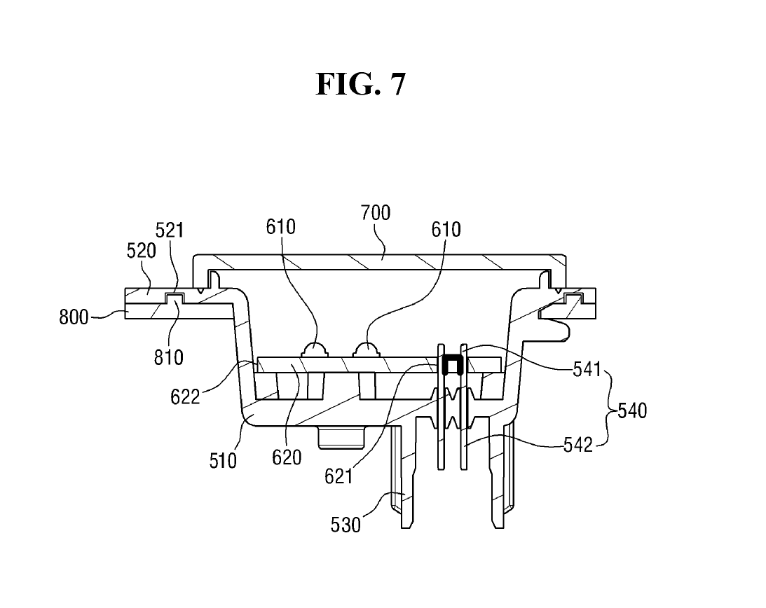

FIG. 6 is a detailed view of a vehicle lamp device 50 according to another exemplary embodiment of the present invention. FIG. 7 is a lateral cross-sectional view of the vehicle lamp device 50 of FIG. 6. The vehicle lamp device 50 according to the current exemplary embodiment of the present invention will now be described with reference to FIGS. 6 and 7, and a redundant description of elements identical to those described above with reference to FIGS. 1 through 3 will be partially omitted.

The vehicle lamp device 50 according to the current exemplary embodiment may include a housing 500, a light source unit 600, and a lens 700. The housing 500 may include an accommodating portion 510 having an opening 511 at a first side thereof and connector pins 540 which have first ends 541 disposed in the accommodating portion 510. The light source unit 600 may be disposed in the accommodating portion 510 and may include one or more light sources 610 configured to irradiate light toward the open first side of the accommodating portion 510. The lens 700 may be coupled to the open first side of the accommodating portion 510 and may be configured to transmit light irradiated from the light sources 610.

In the light source unit 600 according to the current exemplary embodiment, two light sources 610 may be installed on a PCB 620. In other words, the light source unit 600 may include a plurality of light sources 610. Accordingly, while a first lens 310 (see FIG. 3) described above is omitted in the current exemplary embodiment, it may be installed even when there are a plurality of light sources as will be obvious to those of ordinary skill in the art. In addition, the connector pins 540 may be integrally formed with the housing 500 by insert injection, and apertures 621 through which the first ends 541 of the connector pins 540 pass may be formed in the PCB 620 of the light source unit 600. Further, one or more guide protrusions 622 may protrude outward from both ends of the PCB 620, and guide grooves 512 into which the guide protrusions 622 are inserted may be formed in the accommodating portion 510. When the guide protrusions 622 slide along the guide grooves 512, the light source unit 600 may be slid into the housing 500.

Additionally, the housing 500 may include an extending portion 520 that extends outward from the open first side of the accommodating portion 510, and one or more fitting grooves 521 may be formed in the extending portion 520. The vehicle lamp device 50 may also include a pad 800 coupled to the housing 500 while covering the circumference of the housing 500 to prevent the introduction of foreign matter into the housing 500. In addition, one or more fitting protrusions 810 fitted into the fitting groove 521 may be formed on the pad 800. When the fitting protrusions 810 are fitted into the fitting grooves 521, the pad 800 may be more tightly coupled to the housing 500 (e.g., the seal there between may be improved). In an exemplary embodiment, however, the pad 800 and the housing 500 may also be coupled to each other using an adhesive or by ultrasonic welding described above.

Exemplary embodiments of the present invention provide at least one of the following advantages. A vehicle lamp device and a method of manufacturing the same according to the present invention require a reduced number of parts. The reduced number of parts may improve production efficiency, save cost, and reduce the size of the vehicle lamp device. In addition, since a connector pin may be insert-injected into a housing, cracks formed in the process of assembling the vehicle lamp device may be prevented. Furthermore, a grounding defect between the connector pin and a light source unit due to vibrations of a vehicle may be prevented. However, the effects of the present invention are not restricted to the one set forth herein. The above and other effects of the present invention will become more apparent to one of daily skill in the art to which the present invention pertains by referencing the claims.

While the exemplary embodiments of the present invention have been shown and described, the present invention is not restricted by the specific embodiment. It is to be appreciated that those skilled in the art can modify the exemplary embodiment in various ways without departing from the scope and spirit of the present invention and the modified exemplary embodiments should not be construed individually from the technical spirit or prospect of the present invention.

What is claimed is:

1. A vehicle lamp device, comprising:
a housing having an accommodating portion with an open side and a connector pin disposed within the accommodating portion;
a light source unit disposed within the accommodating portion and including one or more light sources configured to irradiate light toward the open side of the accommodating portion; and
a lens coupled to the open side of the accommodating portion and configured to transmit light irradiated from the light sources,
wherein the connector pin is integrally formed with the housing by insert injection, and the light source unit includes a printed circuit board (PCB) having an aperture through which an end of the connector pin passes and the light sources which are installed on the PCB and irradiate light.

2. The vehicle lamp device of claim 1, wherein the accommodating portion includes one or more guide protrusions which protrude inward, and the PCB includes one or more guide grooves inserted into the guide protrusions and moved along the guide protrusions.

3. The vehicle lamp device of claim 1, wherein the accommodating portion includes one or more guide grooves and the PCB includes one or more guide protrusions inserted into the guide grooves and moved along the guide grooves.

4. The vehicle lamp device of claim 1, wherein the end of the connector pin which passes through the aperture is soldered to the PCB.

5. The vehicle lamp device of claim 1, wherein the lens includes:
a first lens configured to diffuse light irradiated from the light sources; and
a second lens configured to refract light diffused by the first lens in a predetermined pattern.

6. The vehicle lamp device of claim 1, wherein the lens is coupled to the open side of the accommodating portion by ultrasonic welding.

7. The vehicle lamp device of claim 1, further comprising:
a pad coupled to the housing to prevent the introduction of foreign matter into the housing.

8. The vehicle lamp device of claim 7, wherein the housing further includes:
an extending portion which extends outward from the open side of the accommodating portion,
wherein the extending portion includes one or more coupling hooks which protrude toward the pad, and
wherein the pad includes one or more coupling grooves into which the coupling hooks are inserted and hooked.

9. A method of manufacturing a vehicle lamp device, the method comprising:
disposing a light source unit having a PCB and a light source, within a housing through an open side of the housing;
passing an end of a connector pin integrally insert-injected into the housing, through an aperture formed in the PCB of the light source unit and soldering the end to the PCB; and
coupling a lens to the open side of the housing.

10. The method of claim 9, wherein in the disposing of the light source unit within the housing, guide grooves respectively formed at both ends of the PCB are inserted into guide protrusions formed inside the housing and moved along the guide protrusions.

11. The method of claim 9, wherein in the disposing of the light source unit in the housing, guide protrusions respectively protruding from both sides of the PCB are inserted into guide grooves formed inside the housing and moved along the guide grooves.

12. The method of claim 9, wherein in the coupling of the lens to the open side of the housing, the lens is coupled to the open side of the housing by ultrasonic welding.

13. The method of claim 9, further comprising:
coupling a pad to the housing to prevent the introduction of foreign matter into the housing.
